(19) United States
(12) Patent Application Publication
(10) Pub. No.: US 2024/0367634 A1
(43) Pub. Date: Nov. 7, 2024

(54) METHOD FOR DETERMINING OPERATING VARIABLES OF A DRUM BRAKE, ASSOCIATED DRUM BRAKE ASSEMBLY, ANALYSIS DEVICE AND STORAGE MEDIUM

(71) Applicant: Continental Automotive Technologies GmbH, Hannover (DE)

(72) Inventors: Christian Vey, Petersberg (DE); Jens Hoffmann, Darmstadt (DE); Martin Kruse, Frankfurt am Main (DE); Mathias Haag, Darmstadt (DE); Martin Gädke, Hofheim (DE)

(73) Assignee: Continental Automotive Technologies GmbH, Hannover (DE)

(21) Appl. No.: 18/686,445

(22) PCT Filed: Nov. 29, 2021
(86) PCT No.: PCT/DE2021/200223

§ 371 Date: Feb. 26, 2024

(30) Foreign Application Priority Data
Aug. 24, 2021 (DE) 10 2021 209 277.2

(51) Int. Cl. B60T 17/22; B60T 8/172

(52) U.S. Cl. CPC B60T 17/22; B60T 8/172

(57) ABSTRACT

A method for ascertaining operating variables of a drum brake has the following steps: a) recording at least one supporting force of a brake shoe of the drum brake by means of a sensor, and b) ascertaining the operating variable based on the supporting force, the operating variable being selected from the brake lining friction value and the spreading force.

### TECHNICAL FIELD

A method for ascertaining operating variables of a drum brake is disclosed. Also, an associated drum brake assembly, an associated evaluation device and an associated storage medium are disclosed as well.

### BACKGROUND

Drum brakes are often used as service brakes in motor vehicles. They can also perform a parking braking function. In the case of known drum brakes, they are typically actuated hydraulically by a brake cylinder, which in turn is actuated directly by a brake pedal. Thus, a driver of the motor vehicle can achieve a braking effect by pressing the brake pedal.

Drum brakes can also be of electromechanical construction, enabling them to act independently of a hydraulic brake system. This may be appropriate, for example, for a braking function which is triggered directly by vehicle electronics.

By way of example, DE 10 2017 217 413 A1 discloses a method for ascertaining an operating variable of a simplex drum brake with an electric wheel brake actuating device on the basis of an electronic control unit, which has the following steps: a) recording at least one bearing force of a brake shoe of the drum brake by means of a sensor, and b) calculating the operating variable based on the bearing force. Furthermore, DE 10 2017 217 413 A1 recommends to persons skilled in the art a drum brake assembly, having at least one brake shoe, at least one supporting bearing, at least one force sensor on the supporting bearing for measuring a bearing force generated by the brake shoe in the supporting bearing, and an evaluation device, which is configured to perform the method described there.

EP 1 095 834 B1 relates to a brake torque control device of an electric motor vehicle brake system. The vehicle brake system includes electric disk brakes of a vehicle front axle and electrically actuated duo-servo drum wheel brakes of a vehicle rear axle, without a separate recuperative vehicle brake system being described. A vehicle axle drive is not documented. A special design feature of this very specifically implemented duo-servo drum wheel brake is its sensor pin integration with floating spreader and with floating brake shoes placed in a brake drum, without the brake shoes being assigned an abutment fixed on the vehicle (supporting frame).

However, the above solutions can offer further potential for improvement, especially with regard to ascertaining further operating variables of drum brakes.

### SUMMARY

A method for ascertaining operating variables of a drum brake, includes the steps of: a) recording at least one supporting force of a brake shoe of the drum brake by means of a sensor, and b) ascertaining the operating variable based on the supporting force, the operating variable being selected from the brake lining friction value and the spreading force.

By the method described above, it is possible in a simple and reliable way to ascertain the brake lining friction value and/or the spreading force as operating variables of drum brakes.

For the sake of proper understanding, it is mentioned that, in the context of the present embodiments, all electric or hydraulic motor vehicle wheel brake systems be regarded as an embodiment of a drum brake as a component of an electric or electromechanical and/or hydraulic drum wheel brake system (friction brake system), and for example those which have at least one motor vehicle axle, which in turn has at least two drum wheel brakes as a service brake. Either another motor vehicle axle may be disk-braked, or all of the service brakes in a motor vehicle may designed as drum brakes. At least one of the mentioned vehicle axles of the motor vehicle brake system is still a driven vehicle axle, which may have a special drive train brake. In the case of a drive train brake, it may be an additional brake system that can be operated individually and/or in concert with the friction brake, in particular a recuperative brake system, an engine brake, a retarder, etc., which on the one hand allows wheel slip and is also able or intended to impart an additional, for example recuperative, braking effect on the respective vehicle axle, as required.

Therefore, it is possible in principle that all of the motor vehicle wheel brakes are designed as the drum brake type. In principle, the drum wheel brake system(s) may still have parking wheel brakes. This is combinatorial in the sense of a combined service and parking brake, it being possible for it to concern parking wheel brakes, service wheel brakes and/or combined wheel brakes of the drum brake type, which could take over both a service braking function and a parking braking function. In the context of the embodiments, the electric and/or hydraulic service wheel brakes of the drum brake type always have wheel brake-individually provided, electromotive, actuating devices as well as assigned, wheel brake-individual sensors, such as in particular brake force sensors, wheel rotation sensors, and/or actuation current measurement on the brake actuator or drum brake actuating device.

In principle, the drum brake may be an electromechanical drum brake.

The embodiments are based on an estimation, of a wheel-individual wheel brake friction value and/or a wheel-individual spreading force, so that a qualitative statement about the braking quality of a single wheel brake can be made wheel-individually. As explained in greater detail below, it goes without saying that the result obtained can be provided and used just the same for the further development or improvement of the parking brake or parking braking function without departing from the core concept of the embodiments.

In order to ascertain the operating variables selected from the brake lining friction value and the spreading force, the method described here comprises first, according to method step a), recording at least one supporting force of a brake shoe of the drum brake by means of a sensor.

The supporting force or the bearing force in the supporting bearing may be measured on a supporting bearing of the brake shoe. A further supporting force is also preferably measured on a further supporting bearing of the further brake shoe. As a result, the supporting force or the further supporting force can be measured directly at respective supporting bearings, while the brake shoes can be supported in the supporting bearings on other parts of the drum brake.

The supporting forces (F_{Abutment}) have a dependence on variable boundary conditions, such as for example the brake lining friction value, spreading force, etc. of the brake. To ascertain the brake lining friction value (μ_{Lining}) and the spreading force (F_{Spread Unit}) in the operational case of braking with a rotating drum, the calculation of the supporting forces is found to be a suitable criterion. In this case, the amounts, for example of both supporting forces or the supporting forces of both brake shoes of a drum brake, clearly describe a brake lining friction value and a spreading force. These operating variables can thus be ascertained from the supporting force or forces.

According to the embodiments, this takes place according to method step b), ascertaining the operating variable based on the supporting force, the operating variable being selected from the brake lining friction value and the spreading force.

In detail, the brake lining friction value or the spreading force can be ascertained as follows.

Regarded as the basis of the consideration is a resulting braking torque, for example the difference of the supporting forces on a supporting frame of the brake shoes, the spreading force and the brake lining friction value being ascertained in dependence on the supporting forces. Based on the supporting force measurement, a suitable brake friction value is ascertained (estimated) by means of the measured force values in relation to a leading brake shoe and in relation to a trailing brake shoe. With this information, the resulting spreading force of the actuating device is estimated in specific terms as an alternative to or in addition to the brake friction value, without the need for further sensors in a spreading device. For this purpose, both diametrically opposed forces (from the leading side and the trailing side) on the supporting bearing may be measured.

Although the embodiment is fundamentally suitable for various drum brake designs, an application is in connection with the drum wheel brakes of the simplex type, which each have a brake shoe supported on an abutment in a leading manner and a brake shoe supported on an abutment in a trailing manner, and this abutment bearing one and/or more brake supporting force/bearing sensors. It goes without saying that the terms “trailing” and “leading” are always defined here in relation to a direction of wheel rotation (“forward travel”). A brake system includes actuating means and/or sensors for detecting a braking request.

In principle, therefore, the present embodiments are fundamentally based on the basic concept that an automated friction force ascertainment is performed automatically or during a service braking operation, and that the result of this friction force ascertainment is used for ascertaining a resulting brake application force, and, in a subsequent process step, can be used as a basis for also performing an ascertainment, a calculation and/or an estimation of a drum brake characteristic value and/or drum brake operating value wheel-individually in relation to the respectively investigated drum wheel brake, as described below in greater detail.

In this connection, the present embodiments accordingly allow for the first time an equally economical as well as automatable and also wheel-individual control and/or observation of the braking function quality. The method may be started in situ, i.e. at the same time as and on the occasion of or in parallel with ongoing operation of the wheel brake (service brake).

In addition to the ascertainment of the operating variables described above, it may be that at least one further parameter of the brake is ascertained from the operating variable. A further parameter of the brake may be meant for example as being a parameter of the brake itself or else of a braking function. This allows more detailed control of the braking behavior and thus further improved and safe operation of the brake.

In particular in the case of a hybridized form of vehicle brake system, which has both hydraulic wheel brake actuators and electromechanical wheel brake actuators, which for the interpretation of the various braking functions (service braking function, parking braking function) may be organized in different or common brake circuits, and with the open-loop and/or closed-loop control of the relevant wheel brakes being intended to take place simultaneously, a hydraulic wheel brake pressure that is measured by sensors and wheel-individually is taken to be a further operating variable that can additionally be processed in parallel in the control unit.

In this design, the present embodiments are for example suitable and possibly intended for providing very special characteristic variables for the purpose of refined open-loop and/or closed-loop control of a drum brake system or for the purpose of improving an electromechanical drum brake, which for example are available as feedback variables that can be used in a further developed form.

An example of such a parameter of the brake may be the brake characteristic value C*. For example, with knowledge of the brake characteristic value C* known in principle to the skilled person, the brake can be optimized to achieve particularly advantageous functionality.

It may also be that the method further comprises carrying out a brake diagnosis or is used in the course of a brake diagnosis. This allows the function of the brake to be monitored on the basis of the ascertained brake characteristic values and/or operating variables, and thus a reliable function to be ensured. A brake diagnosis or wheel brake diagnosis can be performed for example periodically or during each braking operation.

In this design, further options for vehicle brake system expansion can thus be made possible.

For example, a brake diagnosis or wheel brake diagnosis may be based on a corresponding characteristic value generation. The characteristic value may be for example one of the aforementioned operating variables and/or brake characteristic values. As a non-limiting example, a brake diagnosis may be based on a wheel-individual ascertainment of a brake lining friction value.

Alternatively or in addition, a wheel brake diagnosis may be based on the determination of an internal brake ratio, also known as C* determination.

The ascertainment of the actuator spreading force may also be used for a brake diagnosis and/or for a more precise actuating force rating.

Based on the brake diagnosis, positioning of the actuating device can also be made possible hereafter by ascertaining and/or verifying the force-displacement characteristic curve(s), i.e. improved actuator position control at a standstill. This allows a more precise actuating force or an improved parking braking function.

For example, in the sense of a brake diagnosis, it may be that the ascertained operating variable and/or an in particular wheel-individually ascertained brake characteristic value is compared with a setpoint range stored in a memory. The setpoint range may be a specifically stored range or a specific value considering corresponding tolerances. Accordingly, it can be ascertained, for example in the course of a brake diagnosis, whether the brake is working as desired, at least on the basis of the checked parameters.

If the ascertained characteristic value is occupied beyond the stored setpoint range, an automatic countermeasure may be started and/or an automatic error message output or issued. In other words, it is provided that, if the brake characteristic value does not correspond to the stored setpoint range, at least one of either a countermeasure and an error message is initiated.

With reference to an electronic brake system, for example, the embodiments thus allow an improved open-loop actuating device control or closed-loop actuating device control made more precise in a further developed form, and accordingly a wheel-individually embodied braking torque distribution between individual wheel brakes of a motor vehicle. As a result, this allows an electronic braking torque distribution (EBD) between the wheel brakes of various motor vehicle axles that is improved in a situationally open-loop/closed-loop controlled manner without putting driving stability at risk.

With respect to further technical features of the method, reference is made to the description of the drum brake assembly, the evaluation device and the storage medium and to the figures as well as the description of the figures, and vice versa.

Also described are a drum brake assembly, having at least one brake shoe, at least one supporting bearing, at least one force sensor on the supporting bearing for measuring a supporting force generated by the brake shoe in the supporting bearing, and an evaluation device, which is configured to perform a method as described above.

Such a drum brake assembly can thus in principle be designed as known per se and have a force sensor on the supporting bearing for measuring a supporting force generated by the brake shoe in the supporting bearing. Such a sensor is known in principle to the skilled person in the field. In addition, the drum brake system has a corresponding evaluation device. This may be for example a control system of the vehicle or part of it and be provided with software which triggers a method, whereby the data of the sensor are recorded for ascertaining the supporting force and accordingly the operating variables are ascertained as explained in detail above with reference to the method.

The drum brake assembly may also have at least one further brake shoe, at least one further supporting bearing, and at least one further force sensor on the further supporting bearing for measuring a further supporting force generated by the further brake shoe in the further supporting bearing. As detailed above, the evaluation unit is configured to perform a method as described above.

The assumed starting point/subject matter is thus for example an electromechanically operated drum brake as a service brake, it also being possible for a parking braking function to be performed by the drum brake or not. In this context, the electromechanical drum brake for example being suitable for series production as a service and/or parking brake, in that acting braking forces and/or braking torques can be wheel-individually detected, assessed and, on the basis of the assessment, purposefully corrected, with or without additional braking torques of a recuperative auxiliary brake (drive train brake). In this connection, the brake friction value and/or the spreading force is/are ascertained, such as estimated, and can be assessed. The result of the assessment may be automatically output, for example in order to output a brake malfunction to a driver or to an electronic braking function monitoring system.

The determination of the braking torque on the basis of the measured forces is of great use for the closed-loop control of an electromechanical brake, i.e. for a vehicle deceleration function, but also for a vehicle parking function. This is so because, for the function of the parking brake, the determination of the prevailing, resulting spreading force is also of use for the open-loop and/or closed-loop control of the electromechanical brake in the sense of standstill management. The ascertainment of the brake lining friction value makes a more precise ascertainment, determination and/or calculation of a necessary spreading force possible, and vice versa, for instance for the parking braking function.

Each motor vehicle wheel, i.e. each motor vehicle wheel brake, may be additionally assigned at least one wheel rotation sensor, which in each case contributes wheel-individually with signals for obtaining information about wheel speed and/or direction of wheel rotation. At least the wheel rotation sensor signals of the wheel brake considered, or alternatively the wheel rotation sensor signals of the motor vehicle wheel axle considered and/or the wheel rotation sensor signals of all the wheels, are included in a method for open-loop/closed-loop drum brake control or a brake diagnosis and allow a distinction in specific terms or specification of a braking mode, that is for
a) on the one hand, the parking braking function—in the case of a detected wheel speed of substantially equal to 0, i.e. at a standstill or in a standstill range,
b) regular service braking function in the case of a determined wheel speed of substantially not equal to 0, i.e. beyond a standstill range,
c) regular (driver-initiated) driving dynamics brake control mode, such as for instance ABS/EBD/ESP brake control mode,
d) external control operation, such as for instance collision detection, autonomous or partially automated driving, and
e) drum wheel brake system with detected fault—fault operation, preferably for all of the aforementioned modes or control cases according to a-d.

In principle, further information may include, such as for instance the wheel rotation information, or the wheel rotation sensor signals and/or brake request recognition, or even still broader communication of an electronic control unit, for instance on the basis of networking, such as in particular connection to sensors and/or communication, such as in particular environmental detection, for instance optics, i.e. camera, ultrasound, radar, lidar sensors, Car2X communication. Such information can, in an expansion stage, enable a drum wheel brake system, provided electrically, to be provided to the extent necessary in each case as a service wheel brake or as described otherwise in the framework of the wheel brake control function deemed necessary, in order thereby to provide electronically secured and more reliable drum brake control operation.

With respect to further technical features of the drum brake assembly, reference is made to the description of the method, the evaluation device and the storage medium and to the figures as well as the description of the figures, and vice versa.

Also described is an evaluation device which is configured to perform a method as described above.

The evaluation device may be for example a control system of the vehicle or part of it and be provided with software which records the data of the sensor for ascertaining the supporting force and accordingly ascertains the operating variables as explained in detail above with reference to the method. The software may be stored in a hard disk memory or be readable via a computer-readable mobile storage medium. Furthermore, the evaluation device may have a processor which can read and execute the software.

With respect to further technical features of the evaluation device, reference is made to the description of the method, the drum brake assembly and the storage medium and to the figures as well as the description of the figures, and vice versa.

Also described is a non-volatile computer-readable storage medium which contains program codes, during the execution of which a processor performs a method as described above. The storage medium may be for example a mobile storage medium, such as a memory card, a CD or a similar medium, or else an immobile storage medium, such as for instance a hard disk. The storage medium is provided with software which contains the program codes and accordingly instructions for a processor for performing the method.

With respect to further technical features of the computer medium, reference is made to the description of the method, the drum brake assembly and the evaluation device and to the figures as well as to the description of the figures, and vice versa.

The embodiments is explained in more detail below on the basis of the figures, wherein one or more features of the figures can be a feature of the embodiments, either alone or in combination. Furthermore, the figures are only to be seen as examples but not restrictive in any way.

### BRIEF DESCRIPTION OF THE DRAWINGS

FIG. 1 schematically shows a component of an electromechanical drum brake;

FIG. 2 schematically shows a diagram showing the supporting forces in dependence on the spreading force;

FIG. 3 schematically shows a diagram showing the supporting forces in dependence on the brake lining friction value;

FIG. 4 schematically shows a diagram showing the supporting forces in dependence on the spreading force and the brake lining friction value;

FIG. 5 schematically shows a block diagram for a method; and

FIG. 6 schematically shows ascertained parameters for carrying out the method.

### DETAILED DESCRIPTION OF THE EMBODIMENTS

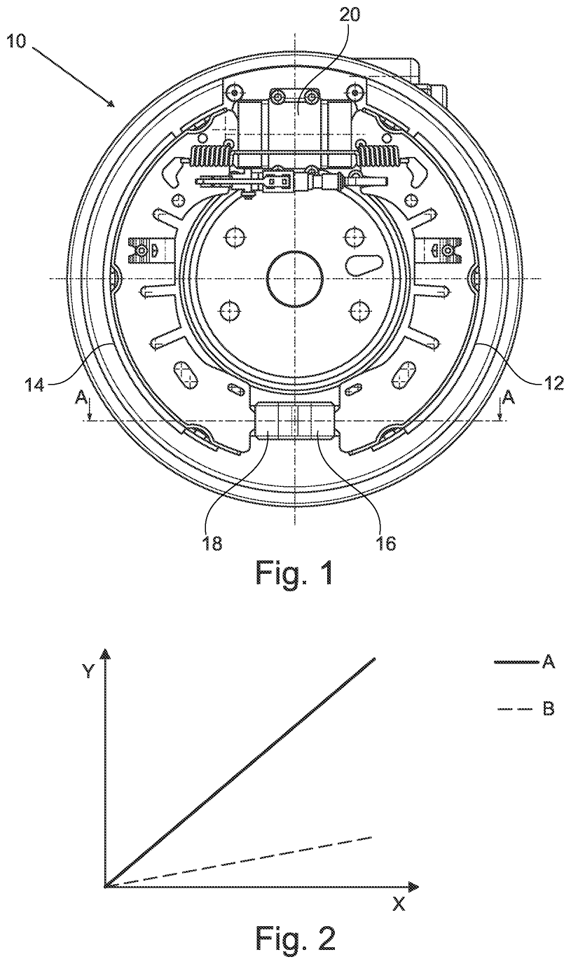

FIG. 1 shows a drum brake assembly 10 with an electromechanical drum brake in a schematic illustration, although the drum is not shown.

The drum brake assembly 10 illustrated in FIG. 1 has a first brake shoe 12 and a second brake shoe 14. The drum (not shown) of a drum brake typically surrounds the brake shoes 12, 14. The first brake shoe 12 is supported in a first supporting bearing 16. This contains a first force sensor, which is not shown separately. The second brake shoe 14 is supported in a second supporting bearing 18. This contains a second force sensor, which is not shown separately. The supporting bearings 16, 18 may be arranged on a back plate of the drum not shown.

Between the two brake shoes 12, 14, a spreading unit 20 is arranged on the upper side of the drum brake. In the present case, this is an electromechanical spreading unit 20. This can push the two brake shoes 12, 14 apart, causing them to make contact with a surrounding drum and to brake the drum if it is rotating. If the drum is not rotating, the brake shoes 12, 14 may exert a holding force. Thus, the drum brake 10 can be used both as a service brake and as a parking brake.

When the spreading unit 20 presses the two brake shoes 12, 14 against the inside of the drum, they are supported by reaction forces on the supporting bearings 16, 20. There, the forces which arise as a result are measured.

According to one exemplary embodiment, the drum brake assembly 10 has an evaluation device 22. This is configured for performing a method according to an exemplary embodiment. During this process, the measured forces which have just been mentioned are processed further. The measurement of the forces on the supporting bearing is a prerequisite for a method, a device, components and software for determining the characteristic variables ascertained, that is in particular the brake lining friction value and the spreading force.

In the following, it is described with reference to FIG. 2 to FIG. 5 how the measured supporting forces can be evaluated in the course of a method. Thus, FIGS. 2 to 5 show a method for determining the brake lining friction value and the spreading force.

The measured supporting forces (F_{Abutment}) show a dependence on variable boundary conditions, such as in particular temperature, speed, brake lining friction value, spreading force, etc. of the brake. To ascertain the brake lining friction value (μ_{Lining}) and the spreading force (F_{Spread Unit}) in the operational case of braking with a rotating drum, the calculation of the supporting forces is found to be a suitable criterion.

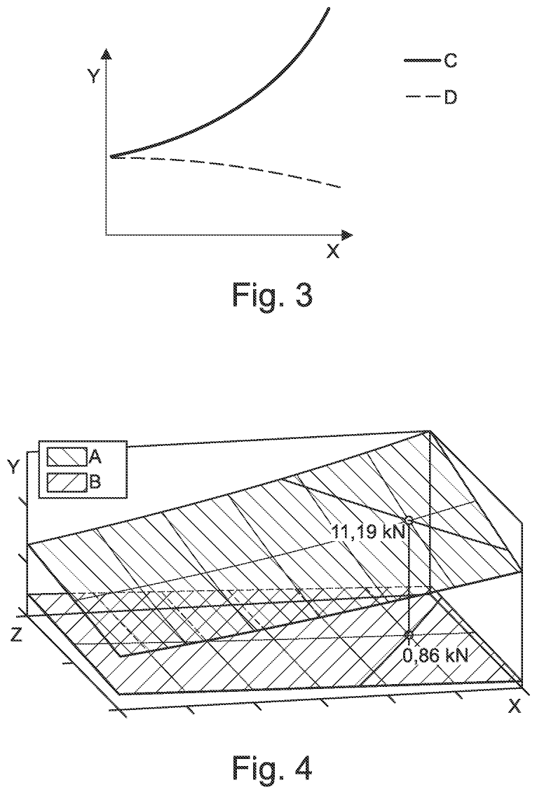

In this case, the amounts of both supporting forces clearly describe a brake lining friction value and a spreading force. FIGS. 2 and 3 show the dependences of the supporting forces, shown in each case on the Y-axis, on the spreading force, shown in FIG. 2 on the X-axis, and the brake lining friction value, shown in FIG. 3 on the X-axis, with in each case the solid line showing the leading side and the dashed line showing the trailing side of the brake shoes 12, 14.

Superposing the two diagrams produces a three-dimensional map in which the clear dependence of force pairs in the supporting bearing with respect to the brake lining friction value and the spreading force can be seen. This is shown in FIG. 4.

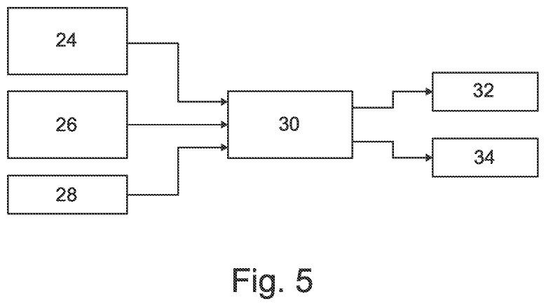

FIG. 5 relates to a block diagram for clarification of the process.

In detail, block 24 shows the sensor for measuring the supporting force of the first brake shoe 12, block 26 shows the sensor for measuring the supporting force of the second brake shoe 14 and block 28 shows further parameters that affect the brake lining friction value and the spreading force, such as for instance the temperature at the brake shoes and the wheel speed. These are preferably included as further input parameters in the calculation, which is intended to be represented as block 30. Subsequently obtained as output values are the brake lining friction value according to block 32 and the spreading force according to block 34.

The figures show that, for the reliable estimation, ascertainment, and calculation of the spreading force and the brake lining friction value, only measurement information on the basis of the measurement results of sensors concerning brake shoe supporting forces as well as geometric parameters of the brake are required as input information.

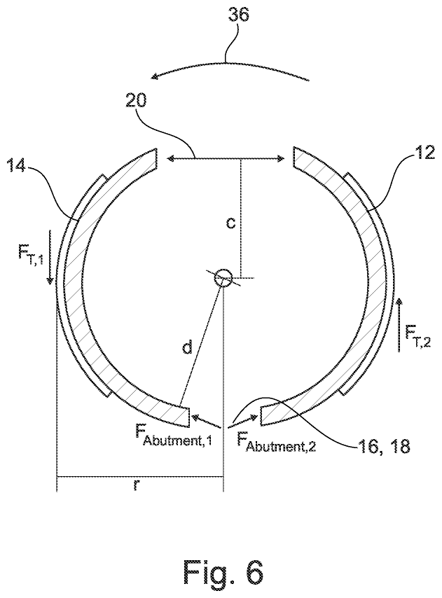

The specific calculation of the brake lining friction value or spreading force is indicated in FIG. 6, which shows a brake as described in FIG. 1, and can be performed as follows.

Shown in detail in FIG. 6 are the forces (F_{Spread Unit}) on the spreading unit 20, the circumferential forces (F_{T}), and the forces (F_{Abutment}) on the supporting bearings 16, 18, respectively represented by the appropriately positioned arrows. This is the basis of the calculation. With reference to a circular shape based on the brake shoes 12, 14, the further parameters describe the distance (c) of the center of the drum brake from the spreading unit 20, the distance (d) of the center of the drum brake from the supporting bearings 16, 18 and the radius (r) of the circular shape of the drum brake at the outer points of the brake linings 12, 14 in the functional state and thus also the inner radius of the drum.

This results in the equation (1), which is known in principle to the skilled person and which represents the torque equilibrium around the center for the respective brake shoe 12, 14 and forms the starting point of the calculation, with the sign +/− applying as the upper sign (in equation (1) +) for the leading brake shoe and applying as the lower value (in equation (1) −) for the trailing brake shoe:

$${F}_{Spread Unit} \cdot c \pm {F}_{T} \cdot r = {F}_{Abutment} \cdot d \qquad ( 1 )$$

The following equations (2) and (3) are used to ascertain the spreading force and the brake lining friction value based on the information of the supporting forces and the geometric variables of the drum brake. Here, equation (2) represents the ascertainment of the brake characteristic value on the basis of the circumferential force and the spreading force and equation (3) represents the dependence of the brake characteristic value on the lining friction value and the parameters H₁-H₅, which are ascertained on the basis of geometric variables:

$${C}^{*} = \frac{{F}_{T}}{{F}_{Spread Unit}} \qquad ( 2 )$$

$${C}^{*} = \frac{{H}_{1} ∓ {μ}_{L i} \cdot {H}_{2}}{{H}_{3} \cdot ( {μ}_{L i} + \frac{1}{{μ}_{L i}} ) + {μ}_{L i} \cdot {H}_{4} ∓ {H}_{5}} \qquad ( 3 )$$

According to the embodiments, it is thus possible to determine the spreading force or the brake lining friction value by using equations (2) and (3), which are known in principle to the skilled person for determining the brake characteristic value C*, and equation 1. In equations (2) and (3) μ_{Li} denotes the brake lining friction value and, as described above, F_{Spread Unit} denotes the spreading force. H1 to H5 are geometric auxiliary variables known to the skilled person for these equations, relating to the specific brake.

By inserting equation (2) and (3) in equation (1) and a corresponding resolution toward the desired parameters, a calculation of the corresponding target variables is possible by a method according to the invention.

Since different motor vehicle manufacturers may demand completely different motor vehicle systems and/or motor vehicle concepts with different brake system interpretations, increased flexibility is sometimes required. In the present context, it may be made possible in addition to this that a brake system control developed in a correspondingly hybridized manner is defined. In this case, not only hydraulic wheel brake actuators but also electromechanical wheel brake actuators as well as possibly at least one recuperative brake are present side by side in a motor vehicle system and the wheel brake actuators may require correspondingly different operating variables and/or actuating variables. In order therefore also to allow a jointly performable method as well as a common evaluation device 22, this evaluation device 22 is to be fed in parallel, as an additional operating variable, at least one hydraulic wheel brake pressure p that is measured by sensors and wheel-individually, and with the common evaluation device 22 at the same time ascertaining on the basis of this additional operating variable wheel-individual wheel brake setpoints and imparting them to the wheel brakes in such a coordinated manner that simultaneously parallel open-loop and/or closed-loop control of all of the brakes in the hybridized motor vehicle system is made possible. Accordingly, the common evaluation device 22 may be assigned at least one brake pressure sensor S for at least one hydraulically actuated wheel brake, and with the brake pressure sensor S electrically connected to the common evaluation device 22, and the common evaluation device 22 may also be assigned at least one brake pressure control valve for hydraulic brake pressure control of the hydraulically actuated wheel brake, so that the common evaluation device 22 is thereby fundamentally and systematically enabled, for example separately or together with all of the other brakes (including the recuperative brake) in the hybridized system, additionally also to control a wheel brake pressure p of the hydraulically actuated wheel brake(s) in an open-loop and/or closed-loop manner.

1. A method for ascertaining operating variables of a drum brake comprising:
recording at least one supporting force of a brake shoe of the drum brake with a sensor, and
ascertaining at least one operating variable based on the supporting force, the operating variable being selected from the brake lining friction value and the spreading force.

2. The method as claimed in claim 1, wherein the supporting forces of two brake shoes of a drum brake are measured.

3. The method as claimed in claim 1, wherein at least one further parameter of the brake is ascertained from the operating variable.

4. The method as claimed in claim 3, wherein the further parameter of the brake is a brake characteristic value.

5. The method as claimed in claim 1, further comprising carrying out a brake diagnosis or is used in the course of a brake diagnosis.

6. The method as claimed in claim 1, wherein at least one of the ascertained operating variable and an ascertained brake characteristic value is compared with a setpoint range stored in a memory.

7. The method as claimed in claim 6, wherein when at least one the ascertained operating variable and the ascertained brake characteristic value do not correspond to the stored setpoint range, at least one of either a countermeasure and an error message is initiated.

8. The method as claimed in claim 1, wherein an electromechanical drum brake is used as the drum brake.

9. The method as claimed in claim 1, wherein a hybridized brake system control comprises an evaluation device and at least one of: hydraulic wheel brake actuators, electromechanical wheel brake actuators, at least one recuperative brake wherein the at least the wheel brake actuators require different operating variables and/or actuating variables, and further comprising:
feeding at least one hydraulic wheel brake pressure as an additional operating variable to the evaluation device, wherein the at least one hydraulic wheel brake pressure is measured in parallel by sensors for each wheel;
ascertaining on the basis of this additional operating variable wheel-individual wheel brake setpoints with the evaluation device; and
imparting the wheel brake setpoints to the wheel brakes in a coordinated manner for parallel open-loop and/or closed-loop control of all of the brakes.

10. A drum brake assembly comprising:
at least one brake shoe;
at least one supporting bearing;
at least one force sensor on the supporting bearing for measuring a supporting force generated by the brake shoe in the supporting bearing; and
an evaluation device, which is configured with instructions for;
recording at least one supporting force of a brake shoe of the drum brake with a sensor, and
ascertaining at least one operating variable based on the supporting force, the operating variable being selected from the brake lining friction value and the spreading force.

11. The drum brake assembly as claimed in claim 10, further comprising:
at least one further brake shoe;
at least one further supporting bearing; and
at least one further force sensor on the further supporting bearing for measuring a further supporting force generated by the further brake shoe in the further supporting bearing.

12. The drum brake assembly as claimed in claim 10, further comprising:
at least one brake pressure sensor for at least one hydraulically actuated wheel brake, wherein the brake pressure sensor is electrically connected to the evaluation device;
at least one brake pressure control valve for hydraulic brake pressure control of the hydraulically actuated wheel brake actuated by the evaluation device; and
wherein, the evaluation device controls a wheel brake pressure of the at least one hydraulically actuated wheel brake in one of an open-loop and a closed-loop manner.

13. (canceled)

14. A non-volatile computer-readable storage medium which contains program codes, during the execution of which a processor performs said program codes having instructions for:
recording at least one supporting force of a brake shoe of the drum brake with a sensor; and
ascertaining at least one operating variable based on the supporting force, the operating variable being selected from the brake lining friction value and the spreading force.
